(19) United States
(12) Patent Application Publication
(10) Pub. No.: US 2019/0018253 A1
(43) Pub. Date: Jan. 17, 2019

(54) Optical Arrangement and Method for Producing a Combined Beam of a Plurality of Laser Light Sources

(71) Applicant: Fraunhofer-Gesellschaft zur Förderung der angewandten Forschung e.V., München (DE)

(72) Inventors: Thomas Schreiber, Jena (DE); Fabian Stutzki, Jena (DE)

(21) Appl. No.: 16/031,777

(22) Filed: Jul. 10, 2018

(30) Foreign Application Priority Data
Jul. 13, 2017 (DE) 102017115786.7

(51) Int. Cl. G02B 27/10; G02B 27/30; H01S 3/067

(52) U.S. Cl. CPC G02B 27/1006; H01S 3/067; G02B 27/30

(57) ABSTRACT

An optical arrangement and a method for producing a combined beam of a plurality of laser light sources are described. In an embodiment, an optical arrangement includes a linear arrangement of a plurality of laser light sources aligned in parallel and having wavelengths different from each other, wherein the laser light sources are disposed in a plurality of groups, a collimation lens for producing a partial beam bundle for each group of laser light sources and a first diffraction grating onto which the partial beam bundles of the groups of laser light sources impinge adjacent to one another, following the collimation lenses, wherein the first diffraction grating is configured to deflect the partial beam bundles onto a second diffraction grating, and wherein the second diffraction grating is configured to deflect the partial beam bundles such that the bundles are combined into an overall beam bundle.

### CROSS-REFERENCE TO RELATED APPLICATIONS

This application claims the benefit of German patent application 10 2017 115 786.7, filed on Jul. 13, 2017, which application is hereby incorporated herein by reference.

### TECHNICAL FIELD

The invention relates to an optical arrangement and a method for producing a combined beam of a plurality of laser light sources, particularly a plurality of fiber lasers, the laser light sources having different emitted wavelengths.

### BACKGROUND

Beam combination of spectrally different laser light sources can be used particularly for achieving high optical output power levels. Producing laser light with very good beam quality becomes more difficult as the output power increases. The highest mean power level with diffraction-limited beam quality is currently achieved by means of fiber lasers and is in the range of a few kW. Limiting effects include nonlinear effects such as stimulated Raman or Brillouin scattering and beam instabilities (thermal mode instabilities (TMI)). Further scaling is presumably possible only to a limited degree with future developments in fiber technology, but a significant increase in power presumably cannot be achieved due to said effects. In order to achieve particularly high power levels, it is therefore useful to apply beam combination techniques for combining a plurality of lasers into a common output beam.

### SUMMARY

Embodiments of the invention provide an optical arrangement and a method for producing a combined beam of a plurality of laser light sources, the combined overall beam having a high optical power level and simultaneously high beam quality.

According to at least one embodiment, the optical arrangement for producing a combined beam comprises a plurality of laser light sources. The plurality of laser light sources advantageously form a linear arrangement and are aligned parallel to each other. Here and in the following, a linear arrangement means in particular an arrangement in which the laser light sources are arranged parallel to each other in one plane. The laser light sources have different wavelengths from each other, so that an overall beam comprising all wavelengths of the plurality of laser light sources can be produced by means of the optical arrangement. The wavelengths of the laser light sources can comprise, for example, wavelengths of the visible range of the spectrum, the UV range, and/or the IR range. The wavelengths of the plurality of laser light sources advantageously do not overlap each other within the groups and between the groups. Rather, the linear arrangement of the laser light sources within the groups and the arrangement of the adjacent groups relative to each other are such that all laser light sources of the optical arrangement are disposed in the sequence of the wavelengths thereof.

In various embodiments of the optical arrangement, the laser light sources are advantageously disposed in a plurality of groups. Each group of laser light sources is followed by a collimation lens in the beam direction. The collimation lens can be a single or multiple optical component. A partial beam bundle is produced by the collimation lens and comprises the laser beams of the laser light sources of each group. The partial beam bundle of the group is directed onto a first diffraction grating by means of the collimation lens. The plurality of partial beam bundles impinge on the first diffraction grating adjacent to each other. According to at least one embodiment, the first diffraction grating is set up for deflecting the partial beam bundle onto a second diffraction grating. The second diffraction grating is set up for deflecting the partial beam bundles such that said bundles are combined into an overall beam bundle. The overall beam bundle comprises the partial beam bundles of all groups of laser light sources and thus advantageously the radiation and the wavelength spectrum of the plurality of laser light sources of the optical arrangement.

Optical diffraction gratings, used in the optical arrangement described herein as the first optical diffraction grating and the second optical diffraction grating, typically have a high diffraction efficiency only in a narrow spectral range. In order to achieve high output power, only partial beams comprising wavelengths in the useable spectral range of the diffraction grating can be spectrally combined into an overall beam. The partial beams combined into an overall beam are often designated as channel when combining laser beams into an overall beam. The number of channels able to be combined into an overall beam is typically limited by the requirements for the beam quality to be achieved, the size of the optical arrangement, and the spectral properties of the laser light sources and the diffraction grating.

The optical arrangement described herein is particularly useful in that groups of laser light sources are used instead of individual laser light sources for the channels and are each combined into a partial beam bundle by means of a collimation lens prior to impinging on the first diffraction grating. It is thereby possible to optimally exploit the usable spectral bandwidth of the diffraction grating and to significantly increase the optical output power of the overall beam bundle produced within the spectral bandwidth of the diffraction grating.

In various embodiments, the first diffraction grating and/or the second diffraction grating is a reflective diffraction grating, particularly a dielectric reflective diffraction grating. A particularly high diffraction efficiency can be advantageously achieved by means of a dielectric reflective diffraction grating. Alternatively, however, it is also possible that the first diffraction grating and/or the second diffraction grating is implemented as a transmission grating. In order to achieve a high diffraction efficiency, the first diffraction grating can be used at least nearly in a Littrow arrangement. The first diffraction grating is preferably disposed such that no laser light is reflected back into the laser light source. To this end, an at least minor rotation or tilting of the first diffraction grating can be performed.

In an embodiment, the first diffraction grating is divided into a plurality of partial regions, wherein the partial regions are each provided for diffracting one or more partial beam bundles. In the present embodiment, each partial beam bundle can be advantageously associated with a dedicated partial region of the diffraction grating.

For example, the first diffraction grating can comprise six partial regions for diffracting six partial beam bundles. Alternatively, it is also possible that the plurality of partial regions are provided for diffracting more than just one partial beam bundle each. For example, the first diffraction grating can comprise three partial regions for diffracting six partial beam bundles, wherein each partial region is provided for diffracting two adjacent partial beam bundles. The allocation of the first diffraction grating into a plurality of partial regions has the advantage that each partial region can be optimized with respect to diffraction efficiency for the wavelengths of the associated partial beam bundle or the associated partial beam bundles.

The partial regions of the first diffraction grating preferably each comprise a grating structure adapted to the emitted wavelength range of the associated group(s) of laser light sources. All partial regions of the first diffraction grating thereby advantageously comprise the same grating period, but are differentiated from each other at least by one other property of the grating structure. The first diffraction grating can, for example, comprise a dielectric alternating layer system having a periodic structure disposed thereon. The partial regions of the first diffraction grating can differ in this case, for example, by the properties of the dielectric alternating layer system, for example, in the layer thickness and/or the materials used. Alternatively or additionally, the partial regions can differ from each other by the properties of the periodic structure, for example, the depth of the periodic structure.

According to an embodiment of the optical arrangement, the laser light sources are fiber lasers or fiber amplifiers, particularly fundamental mode fiber lasers or fundamental mode fiber amplifiers. Particularly high optical output power levels with good beam quality can be achieved by means of fiber lasers or fiber amplifiers.

If the laser light sources of the optical arrangement are fiber lasers or fiber amplifiers, then it is advantageously possible to arrange the laser light sources of a group in one common fiber plug. The fiber plug advantageously allows relatively simple replacement of the laser light sources in case of a defect.

The arrangement of the fiber lasers or fiber amplifiers in a group may further facilitate the adjusting of the laser light sources into a linear arrangement. It is particularly advantageous for the adjusting if one group comprises exactly two fiber lasers or fiber amplifiers. In this case, any tilting of the arrangement relative to an adjusting plane can be corrected in a simple manner by rotating the fiber plug.

According to a further advantageous embodiment, the laser light sources are each fiber lasers or fiber amplifiers, wherein the fiber lasers or fiber amplifiers of a group are each formed by different fiber cores of a multicore fiber. In the present embodiment, the linear arrangement of the fiber cores can be produced during manufacture of the multicore fiber. In the case of a multicore fiber, it is further advantageous with respect to adjusting if the multicore fiber comprises exactly two fiber cores, because in this case any tilting of the arrangement relative to an adjusting plane can be corrected by rotating the multicore fiber, for example, in a fiber plug.

According to an embodiment of the method for producing a combined beam of a plurality of laser light sources, the laser light sources are disposed in a linear arrangement and emit laser light parallel to each other, wherein the laser light sources comprise different wavelengths from each other. The laser light sources are disposed in a plurality of groups, wherein the laser light of the laser light sources of each group is collimated by means of a collimation lens associated with the group and a partial beam bundle is thus produced for each group, wherein the partial beam bundle is directed onto a first diffraction grating. The partial beam bundles impinge on the first diffraction grating adjacent to each other and are deflected by the first diffraction grating onto a second diffraction grating. The partial beam bundles are deflected by the second diffraction grating so as to be combined into an overall beam bundle.

The embodiments described in the context of the optical arrangement also apply to the method, and vice versa.

The optical arrangement and the method can be used particularly for combining the laser beams of a plurality of laser light sources having high optical power into an overall beam bundle having very high optical power and high beam quality. The laser light sources preferably each comprise an optical power level of at least 1 kW or even of at least 5 kW. The overall beam bundle produced by means of the optical arrangement and/or of the method advantageously comprises an optical power of greater than 10 kW or even of at least 100 kW. The overall beam bundle thus produced is particularly suitable for applications requiring very high optical power levels, particularly for lasers in material processing or for high-energy lasers (HEL) able to be used for military purposes, for example.

### BRIEF DESCRIPTION OF THE DRAWINGS

The optical arrangement and the method are explained in greater detail below using figures.

FIG. 1 shows a schematic view of a combined spectrum of a plurality of laser light sources;

FIG. 2 shows a schematic view of superimposing beams of a plurality of laser light sources by means of a lens and a diffraction grating;

FIG. 3 shows a schematic view of superimposing beams of a plurality of laser light sources by means of a diffraction grating;

FIG. 4 shows a schematic view of superimposing beams of a plurality of laser light sources by means of a first diffraction grating and a second diffraction grating;

FIG. 5 shows a schematic view of an embodiment of the optical arrangement;

FIGS. 6A, 6B, and 6C show schematic views of embodiments of the first diffraction grating;

FIG. 7 shows a schematic view of an embodiment of the laser light sources as fiber lasers or fiber amplifiers;

FIG. 8 shows a schematic view of a further embodiment of the laser light sources as fiber lasers or fiber amplifiers in a common fiber plug; and

FIG. 9 shows a schematic view of a further embodiment of the laser light sources as fiber cores of a multicore fiber.

Elements in the figures that are either identical, or have the same effect as one another, are given the same reference numbers. The components shown and the relative sizes of the components relative to each other are not to be considered true to scale.

### DETAILED DESCRIPTION OF ILLUSTRATIVE EMBODIMENTS

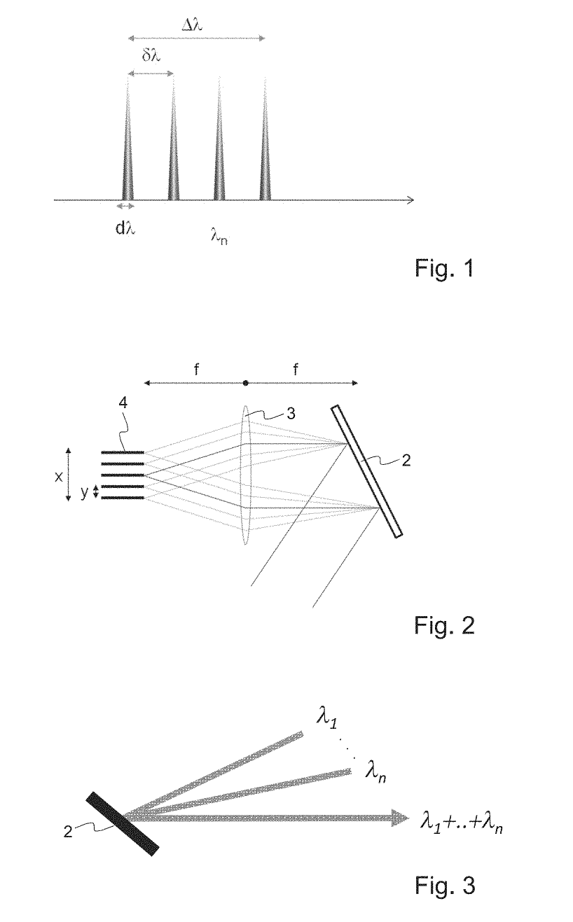

FIG. 1 shows a schematic representation of a spectrum of four laser light sources having wavelengths λₙ different from each other. When combining spectrally different laser light sources, the individual light sources are often referred to as channels. The center wavelength of the nth channel is λₙ, the spectral width of a single channel is dλ, the spacing between two adjacent channels is δλ, and the total width of the combined spectrum is Δλ (difference between the greatest and least wavelength).

FIG. 2 shows a schematic representation of a potential combining of beams of a plurality of laser light sources 4. The plurality of spatially closely spaced laser light sources 4 having wavelengths λₙ different from each other are collectively imaged onto a diffraction grating 2 by a lens 3 of focal length f. After the beams pass through the lens 3, the beams outside of the optical axis impinge on the diffraction grating 2 at a different angle than the beams on the optical axis. The wavelengths of the radiation and the diffraction angle of the grating are related by the grating equation such that a common beam is formed.

For the additional potential for combining beams of a plurality of laser light sources shown in FIG. 3, individually collimated beams of different wavelengths (λ₁ . . . λₙ) impinge on a diffraction grating 2. The angle of impingement of the collimated beams and the grating parameters are adjusted such that the beams are united into a common beam by the diffraction at the diffraction grating 2.

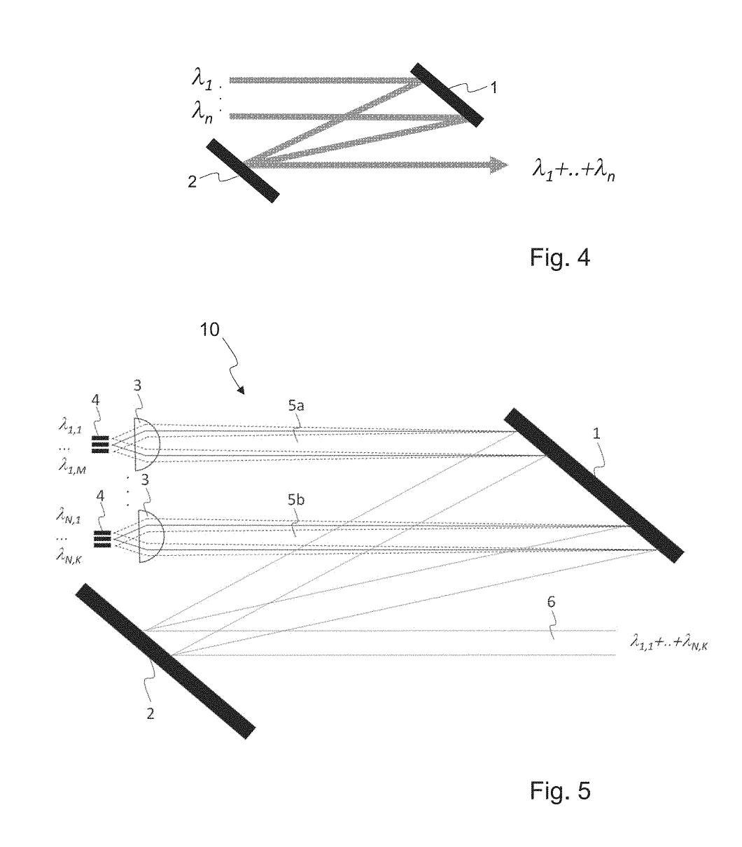

FIG. 4 shows a further potential for combining beams of a plurality of laser light sources having different wavelengths (λ₁ . . . λₙ). The individually collimated laser beams thereby first impinge on a first diffraction grating 1, and said grating deflects the beams to a second diffraction grating 2 by which the beams are combined into an overall beam. In the present arrangement, the diffraction gratings 1, 2 are parallel to each other and have the same grating period. By using two diffraction gratings 1, 2, the splitting of an individual beam can be compensated for due to the spectral width dλ thereof, and thus a higher beam quality can be achieved.

The examples of the FIGS. 1 through 4 described above serve to explain the technical background and individual components of the optical arrangement described herein. Said examples do not, however, describe all features of the optical arrangement described herein.

One embodiment example of the optical arrangement 10 according to the principle proposed herein is shown in FIG. 5. The optical arrangement 10 comprises a plurality of groups of laser light sources 4, wherein the number of groups is N. For example, a first group comprises a number M of laser light sources 4 having wavelengths λ_{1,1} . . . λ_{1,M} different from each other, and the Nth group comprises a number K of laser light sources 4 having wavelengths λ_{N,1} . . . λ_{N,K}. To simplify the representation, only the first group and the Nth group of laser light sources 4 are shown in FIG. 5, wherein one or more further groups of laser light sources 4 can be disposed in between. Each group of laser light sources 4 is followed by a collimation lens 3. The collimation lenses 3 each produce partial beam bundles 5a, 5b comprising the laser radiation emitted by the laser light sources 4 of each group. The partial beam bundles 5a, 5b of the groups of laser light sources 4 are imaged onto the first diffraction grating 1 by each of the collimation lenses 3. The plurality of partial beam bundles 5a, 5b are deflected by the first diffraction grating 1 onto a second diffraction grating 2, wherein the second diffraction grating 2 combines the partial beam bundles 5a, 5b into an overall beam bundle 6. The overall beam bundle 6 advantageously comprises the wavelengths of all laser light sources 4 of the plurality of groups.

The optical arrangement 10 particularly makes use of the idea of directing collimated partial beam bundles 5a, 5b onto the first diffraction grating 1 instead of collimated individual beams (as shown in the example of FIG. 4), wherein the partial beam bundles 5a, 5b each comprise the collimated radiation of a plurality of laser light sources 4. In this manner, the optical output power of the overall beam bundle 6 produced can be significantly increased. Using the references according to FIG. 1, the adjacent channels formed by collimated individual beams comprise a spacing of δλ in the beam combination according to FIG. 4.

The spectral spacing δλ is advantageously filled in by further channels in the form of laser light sources 4 in the embodiment example of FIG. 5, such that collimated groups of laser light sources 4 are used instead of collimated individual laser light sources and are imaged onto the diffraction grating 1. If each group comprises four laser light sources 4, for example, then quadruple the output power can be achieved in this manner.

For Yb-doped fiber lasers, for example, output power levels of 1 kW or greater can be achieved in the wavelength range from 1030 nm to 1100 nm. It is possible to achieve a diffraction efficiency of greater than 95% in the wavelength range from approximately 1030 nm to approximately 1070 nm by means of a dielectric reflective diffraction grating, so that the usable spectral range of the diffraction gratings 1, 2 is approximately 4 nm. For a channel spacing δλ of 4 nm, for example, in this case only 11 channels would be possible when using individual laser light sources such as in the example of FIG. 4, for example, having wavelengths of 1030 nm, 1034 nm, . . . , 1070 nm.

For the optical arrangement 10 according to FIG. 5, for example, the plurality of groups of laser light sources 4 can comprise an average spectral spacing of δλ=4 nm, wherein the groups each comprise a plurality of laser light sources within the spectral spacing δλ. For example, a first group can comprise four laser light sources 4 having wavelengths of approximately 1030.0 nm, 1030.5 nm, 1031.0 nm, and 1031.5 nm, a second group can comprise four laser light sources 4 having wavelengths of approximately 1034.0 nm, 1034.5 nm, 1035.0 nm, and 1035.5 nm, etc., and a final nth group can comprise four laser light sources 4 having wavelengths of approximately 1070.0 nm, 1070.5 nm, 1071.0 nm, and 1071.5 nm. The exact wavelengths result from the dispersion of the diffraction grating, the geometric construction of the lasers, and the collimation thereof. A large number of laser light sources 4 can thus be combined into an overall beam in the usable spectral range of the diffraction grating 1.

The optical arrangement 10 can be particularly provided for producing an overall beam bundle having an optical power level of at least 10 kW, of at least 50 kW, or even of at least 100 kW.

The diffraction gratings 1, 2 in the optical arrangement are preferably reflective diffraction gratings, particularly dielectric reflective diffraction gratings. It is also possible as an alternative, however, that the diffraction gratings 1, 2 are implemented as transmission diffraction gratings. The optical design and production of diffraction gratings 1, 2 are per se known to the person skilled in the art and are therefore not further explained here. In the case of reflective diffraction gratings 1, 2, said gratings are advantageously aligned such that no reflection occurs back in the direction of the laser light sources 4. To this end, at least a slight tilting of the diffraction gratings 1, 2 can be advantageous. The same applies for a transmission diffraction grating reflecting slight portions of the optical power. Such tilting can also allow folding of the beam path.

According to a preferred embodiment, diffraction gratings 1, 2 insensitive to polarization are used. In this case, the laser light sources 4, particularly fiber lasers or fiber amplifiers, need not be polarized.

According to a further advantageous embodiment, the laser light sources 4 themselves are polarized or a polarization is set by means of birefringent plates, for example. When using polarized laser light sources 4, highly dispersive diffraction gratings calculated for polarized radiation and requiring only a small installation space can be used advantageously.

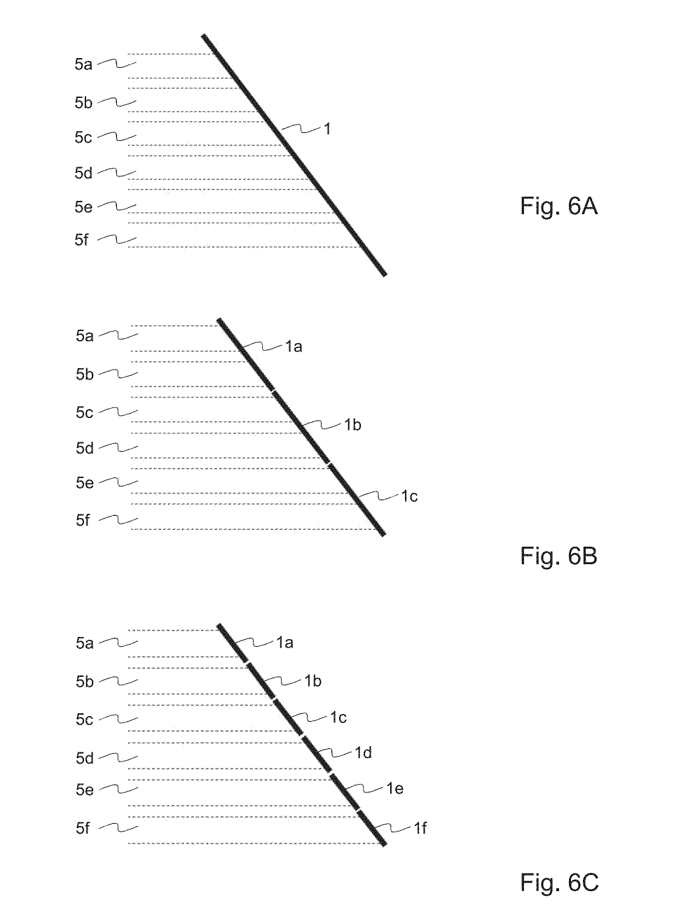

FIGS. 6A through 6C show a plurality of potential embodiments of the first diffraction grating 1 able to be used particularly in the embodiment example of the optical arrangement according to FIG. 5. In the embodiment example of FIG. 6A, the first diffraction grating 1 is a single grating onto which, for example, six partial beam bundles 5a, 5b, 5c, 5d, 5e, 5f from a plurality of groups of laser light sources impinge adjacent to each other.

According to a preferred embodiment example shown in FIG. 6B, the first diffraction grating is a multipart grating, comprising three partial regions 1a, 1b, 1c in the embodiment example. According to the embodiment example of FIG. 6B, two adjacent partial beam bundles 5a, 5b impinge on the first partial region 1a, two adjacent partial beam bundles 5c, 5d impinge on the second partial region 1b, and two adjacent partial beam bundles 5e, 5f impinge on the third partial region.

An embodiment as shown in FIG. 6C is particularly preferred, wherein the first diffraction grating is made of a plurality of partial regions 1a, 1b, 1c, 1d, 1e, 1f, such that each partial beam bundle 5a, 5b, 5c, 5d, 5e, 5f is associated with exactly one partial region of the diffraction grating.

The embodiment of the first diffraction grating as a multipart grating according to FIGS. 6B or 6C has the advantage that each partial region 1a, . . . , 1f can be optimized in terms of diffraction efficiency for the wavelengths of the group or groups of partial beam bundles 5a, . . . , 5f impinging thereon. The partial regions 1a, . . . , 1f advantageously do not differ in grating period, but in at least one other parameter of the grating structure. For example, the diffraction grating can be a reflective diffraction grating comprising a dielectric layer system having a grating structure applied thereto. In this case, for example, the dielectric layer system and/or the grating structure, such as the grating depth, can be optimized in each of the partial regions 1a, . . . , 1f for the wavelengths of the laser light sources of the partial beam bundles 5a, . . . , 5f impinging thereon.

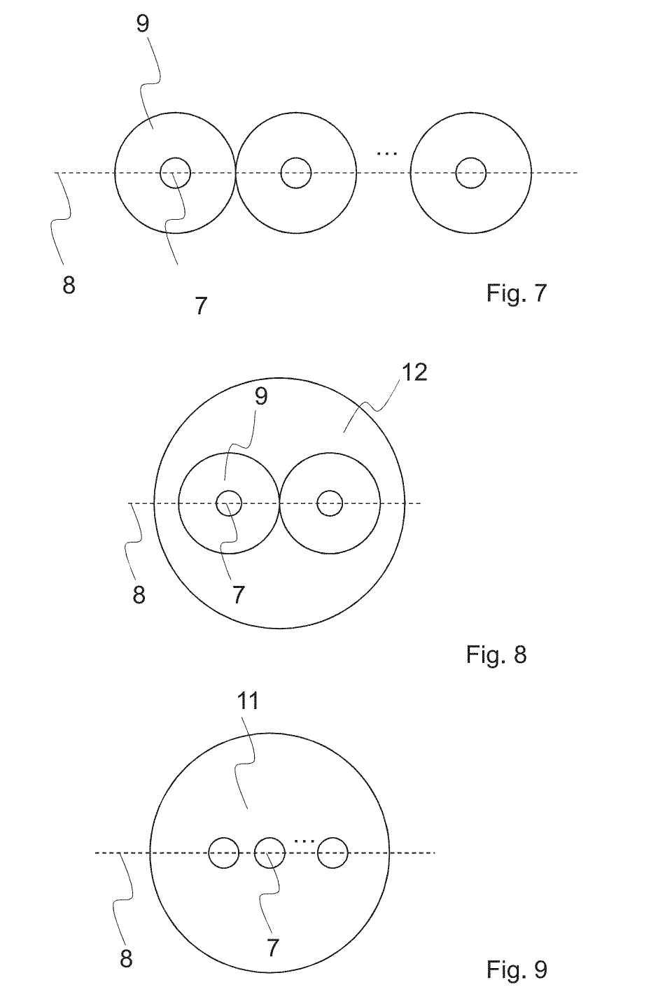

FIG. 7 shows an advantageous embodiment of the laser light sources, wherein the laser light sources are each formed by fiber cores 7 of an optical fiber 9. The laser light sources can be particularly fiber lasers or fiber amplifiers. The fiber cores 7 are adjusted in an adjusting plane 8 so as to form a linear arrangement and to emit in parallel with each other.

In order to facilitate the adjusting of the fiber cores 7 relative to the adjusting plane 8, an embodiment shown in FIG. 8 is advantageous, wherein the fibers 9 having the fiber cores 7 present therein are disposed in a common fiber plug 12. The fiber cores can be adjusted relative to the adjusting plane 8 in this case by rotating the fiber plug 12. The arrangement of the fibers 9 in a fiber plug 12 is also advantageous in that replacing is possible in a simple manner in case of a defect. An arrangement is particularly advantageous with respect to adjusting, wherein exactly two fibers 9 are disposed in a common fiber plug 12. In this case, a linear arrangement of the fiber cores 7 exactly parallel to the adjusting plane can be achieved by simply rotating the fiber plug 12.

A further embodiment of the laser light sources in the form of fiber cores 7 is shown in FIG. 9. In the present embodiment, a plurality of fiber cores 7 are disposed in a linear arrangement in a multicore fiber 11. The fiber cores can be adjusted into a linear arrangement in this case when producing the multicore fiber 11. A variant is preferred for the present embodiment, wherein the multicore fibers 11 comprise exactly two fiber cores 7. In this case, the fiber cores 7 can always be adjusted parallel to the adjusting plane 8 by rotating the multicore fiber 11, for example, in a fiber plug.

The invention is not restricted by the description that refers to the exemplary embodiments. Rather, the invention comprises each new feature, as well as any combination of features, which includes in particular any combination of features in the claims, even if this feature or this combination is not itself explicitly specified in the claims or exemplary embodiments.

What is claimed is:

1. An optical arrangement for producing a combined beam of a plurality of laser light sources, the arrangement comprising:
a linear arrangement of a plurality of laser light sources aligned in parallel and having wavelengths different from each other, wherein the laser light sources are disposed in a plurality of groups;
a collimation lens for producing a partial beam bundle for each group of laser light sources following each group of laser light sources in a beam direction; and
a first diffraction grating onto which the partial beam bundles of the groups of laser light sources impinge adjacent to one another, following the collimation lenses,
wherein the first diffraction grating is configured to deflect the partial beam bundles onto a second diffraction grating, and
wherein the second diffraction grating is configured to deflect the partial beam bundles such that the bundles are combined into an overall beam bundle.

2. The optical arrangement according to claim 1, wherein the first diffraction grating is divided into a plurality of partial regions, and wherein the partial regions are provided for diffracting one or more partial beam bundles.

3. The optical arrangement according to claim 2, wherein the partial regions of the first diffraction grating each comprise a grating structure adapted to an emitted wavelength range of the associated group(s) of laser light sources.

4. The optical arrangement according to claim 1, wherein the laser light sources are fiber lasers or fiber amplifiers.

5. The optical arrangement according to claim 4, wherein the fiber lasers or fiber amplifiers of a group are each disposed in a common fiber plug.

6. The optical arrangement according to claim 4, wherein the fiber lasers or fiber amplifiers of a group are each formed by different fiber cores of a multicore fiber.

7. The optical arrangement according to claim 4, wherein a group is made of exactly two fiber lasers or fiber amplifiers.

8. The optical arrangement according to claim 1, wherein the laser light sources each comprise an optical power level of greater than 1 kW.

9. The optical arrangement according to claim 1, wherein the overall beam bundle comprises an optical power level of greater than 10 kW.

10. A method for producing a combined beam of a plurality of laser light sources, wherein the laser light sources are disposed in a linear arrangement and are configured to emit laser light in parallel with each other, wherein the laser light sources have different wavelengths from each other, and wherein the laser light sources are disposed in a plurality of groups, the method comprising:
collimating the laser light of the laser light sources of each group by a collimation lens thereby forming a partial beam bundle for each group;
directing the partial beam bundles onto first diffraction gratings, wherein the partial beam bundles impinge on the first diffraction gratings located adjacent to each other;
deflecting the partial beam bundles by the first diffraction gratings onto a second diffraction grating; and
deflecting the partial beam bundles by the second diffraction grating so as to form an overall beam bundle.

11. The method according to claim 10, wherein the laser light sources are fiber lasers or fiber amplifiers.

12. The method according to claim 11, wherein the fiber lasers or fiber amplifiers of a group are each disposed in a common fiber plug.

13. The method according to claim 12, wherein one group is made of exactly two fiber lasers or fiber amplifiers.

14. The method according to claim 11, wherein the fiber lasers or fiber amplifiers of a group are each formed by different fiber cores of a multicore fiber.
